(19) United States
(12) Patent Application Publication
(10) Pub. No.: US 2019/0315270 A1
(43) Pub. Date: Oct. 17, 2019

(54) Systems, Methods and Apparatuses for Enhanced Warning Using Laser Diodes for Commercial Vehicle Applications

(71) Applicant: Xuan Bach Ly, London (GB)

(72) Inventor: Xuan Bach Ly, London (GB)

(21) Appl. No.: 16/384,998

(22) Filed: Apr. 16, 2019

Related U.S. Application Data
(60) Provisional application No. 62/658,155, filed on Apr. 16, 2018.

(51) Int. Cl. B60Q 1/52; B60Q 1/30; H05B 37/02; B60R 1/00; F21S 43/13; F21S 43/27; G06T 7/70

(52) U.S. Cl. CPC B60Q 1/525; B60Q 1/30; H05B 37/0218; H05B 37/0227; G06T 2207/30252; F21S 43/13; F21S 43/27; G06T 7/70; B60Q 2400/50; B60R 1/00

(57) ABSTRACT

Apparatuses and methods to project lighting in a physical space adjacent to a vehicle are disclosed. In one aspect, embodiments of the present disclosure include a method, which may be implemented on a system, to decorate a physical target. The apparatus can further include a light source and/or a lens system optically coupled to the light source, wherein, in operation the lens system is adapted to focus or disperse the lighting to illuminate the physical space based on at least one of a position of the physical space relative to the commercial vehicle and an area of the physical space. In general, the light source can include a semiconductor lighting emitting device.

### CLAIM OF PRIORITY

This application claims the benefit of:

* U.S. Provisional Application No. 62/658,155, filed Apr. 16, 2018 and entitled “Systems, Methods and Apparatuses for Enhanced Warning Using Laser Diodes for Commercial Vehicle Applications,” (8001.US00), the contents of which are incorporated by reference in its entirety.

### RELATED APPLICATION

This application is related to:

* Unite Kingdom Patent Application No. ______ , also filed Apr. 16, 2019 and entitled “Apparatus and Method to Project Lighting in a Physical Space Adjacent to a Commercial Vehicle,” (8001.GB01),

which also claims the benefit of:

* U.S. Provisional Application No. 62/658,155, filed Apr. 16, 2018 and entitled “Systems, Methods and Apparatuses for Enhanced Warning Using Laser Diodes for Commercial Vehicle Applications,” (8001.US00), the contents of which are incorporated by reference in their entireties.

### TECHNICAL FIELD

The disclosed technology relates generally to systems, methods and apparatuses to enhance a warning mechanism for vehicles, in particular, commercial vehicles using light emitting devices.

### BACKGROUND

Collisions often occur with a car overtaking a side curtain lorry too closely that is being unloaded with a forklift. Such accidents can be prevented if the person driving the car had been made aware that an unloading procedure were taking place thus staying clear of the lorry.

### BRIEF DESCRIPTION OF THE DRAWINGS

FIG. 1A illustrates an example diagram depicting an aerial view of a vehicle having a device able to project a warning light for indication of a danger zone or a potentially hazardous zone, in accordance with embodiments of the present disclosure.

FIG. 1B illustrates an example diagram depicting a rear view of the vehicle and side view of the vehicle having the device able to project a warning light, in accordance with embodiments of the present disclosure.

FIG. 2A illustrates an example diagram depicting a side view of a vehicle having a vehicle chassis and a device/warning light unit to generate a light projection to illuminate a potentially dangerous or hazardous zone, in accordance with embodiments of the present disclosure.

FIG. 2B-FIG. 2C depict multiple views of an example apparatus to generate and project light to indicate a danger zone or a potentially dangerous zone in in the vicinity of a vehicle, in accordance with embodiments of the present disclosure.

FIG. 3 illustrates an example block diagram depicting a host server 300 able to communicate with a device controller of a warning light unit and/or an imaging unit over a network, in accordance with embodiments of the present disclosure.

FIG. 4 depicts a flow chart illustrating an example process to indicate a zone of hazard in a vicinity of a vehicle, in accordance with embodiments of the present disclosure.

FIG. 5 is a block diagram illustrating an example of a software architecture that may be installed on a machine, in accordance with embodiments of the present disclosure.

FIG. 6 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems, methods and apparatuses to provide enhanced visibility in commercial vehicle applications using light emitting devices. In one embodiment, visibility is provided using warning lights or by surface projection of safety lights. Embodiments of the present disclosure also include apparatuses, vehicles and methods to project lighting in a physical space adjacent to or in a vicinity of a vehicle.

The disclosed innovative apparatus and system can promote and improve healthy and safety in the process of loading/unloading of commercial vehicles in progress. Collisions often occur with a car overtaking a side curtain lorry too closely that is being unloaded with a forklift. Such accidents can be prevented if the person driving the car had been made aware that an unloading procedure were taking place thus staying clear of the lorry. Currently, no existing solution is able to highlight an area where work is commencing. The disclosed technology is advantageous in that it is able to highlight the surface of a hazardous work area to warn personal/drivers in the vicinity to avoid the area.

In one embodiment, the disclosed technology is able to project on the surface of a work area, a clear or bright warning sign/image outlining or otherwise specifying or indicating a hazardous zone. A visible sign/image can be achieved by using a laser diode as the source of light, which can be projected into any suitable lens to achieve the desired size, shape and/or a specified or otherwise designated image.

Example components of the present disclosure include by way of example but not limitation:

*A light source such as a light emitting diodes and/or laser diode(s)—an example of a source of light for projection. Colour options RED: used as a warning/danger color, GREEN: More visible in brighter circumstances.

*A light sensor such as one or more day/night Sensor(s)—can activate system in low light situations.

* A sens system—concave lens, convex lens arrangement or other lens arrangement—can be incorporated bend light into desired size, shape, image.

* Electrical Switch/Trigger—To activate/de-activate automatically or manually.

* Housing Unit—configured or integrated with the unit withstand and protect parts/components from the elements.

* Power Source—coupled to and powered by an internal power source of the vehicle.

* Adjustable Arm—configured and arranged to adjust the position and angle of the light projection (the unit generally is not angled at more than a certain gradient for risk of obscuring vision).

* Projection—configured and adjustable to suit the size of vehicle, and can mirror the width and height of trailer. Height of projection will be combined with the distance from the floor to trailer.

The interaction of warning light apparatus/device and vehicular components can, for example, initiate when vehicular doors/curtains are opened. In one embodiment, the light sensor can for example, relay the electrical witch/trigger (which can be linked into the vehicular interior lighting system) for the unit to activate automatically via a power source (e.g., which can be the vehicle power supply, or be partially or wholly powered by the power supply of the vehicle). The light source can generate the light and can beam into a lens system (e.g., concave lenses, convex lenses or lens arrangement) to projection an image to identify a location of a potentially hazardous area. The adjustable arm can also be positioned/angled such that the projection corresponds with vehicle dimensions.

Note that the light source and the lens system or lens arrangement are generally utilized to achieve a clear and bright image. In some examples, the power source can be replaced by another source e.g. batteries or solar power or used in conjunction with alternative power sources. The housing unit, in some instances, can be incorporated into or integrated within vehicle body or vehicle chassis itself. In one embodiment, the adjustable arm can be individually customized, designed and/or manufactured to suit each and every vehicle/trailer height and width specifications.

Note that the light sensor, Switch/Trigger can be replaced by a manual switch and the unit can be activated manually. Projection could be changed to increase visibility (e.g., colour, language, brightness, etc.) or to include text for example, to convey signage.

In general, the adjustable arm can be optional if the lens or lens arrangement is interchangeable. Note that in this instance, the lens can be configured to tailor to different vehicle dimensions. In general, the disclosed apparatus can be an add-on unit or partially or wholly incorporated into a vehicle structure. As such, some or all of the components including the light sensor, the switch/trigger, and/or the adjustable arm can be wholly or partially incorporated into the disclosed apparatus. Some or all of the components can be in a stand alone unit. Some or all of the components can also be incorporated into the vehicle chassis, vehicle body or vehicle structure.

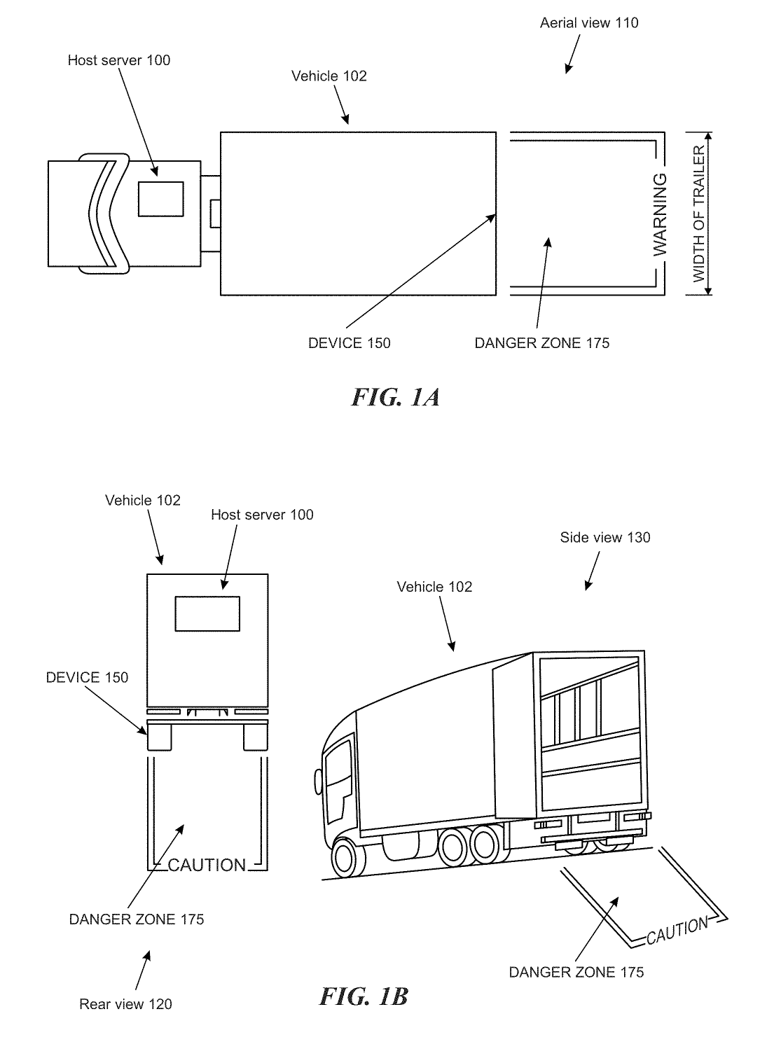

FIG. 1A illustrates an example diagram depicting an aerial view 110 of a vehicle 102 having a device 150 able to project a warning light for indication of a danger zone 175 (e.g., or a potentially hazardous zone), in accordance with embodiments of the present disclosure. FIG. 1B illustrates an example diagram depicting a rear view 120 of the vehicle and side view 130 of the vehicle having the device 150 that is able to project a warning light 175, in accordance with embodiments of the present disclosure.

Note that the vehicle 102 can have integrated therein a host server 100 which is able to receive or process instructions from a vehicle operator of vehicle 102 or a remote operator. The host server 100 is able to communicate with the device 150/apparatus 150 to facilitate, control, adjust, modify, change, and/or otherwise manage the positioning, orientation, timing, color, shade, brightness, intensity, luminescence or other lighting parameters of the projection of lighting into a physical space adjacent to or in a vicinity of a vehicle 102 such as a commercial vehicle.

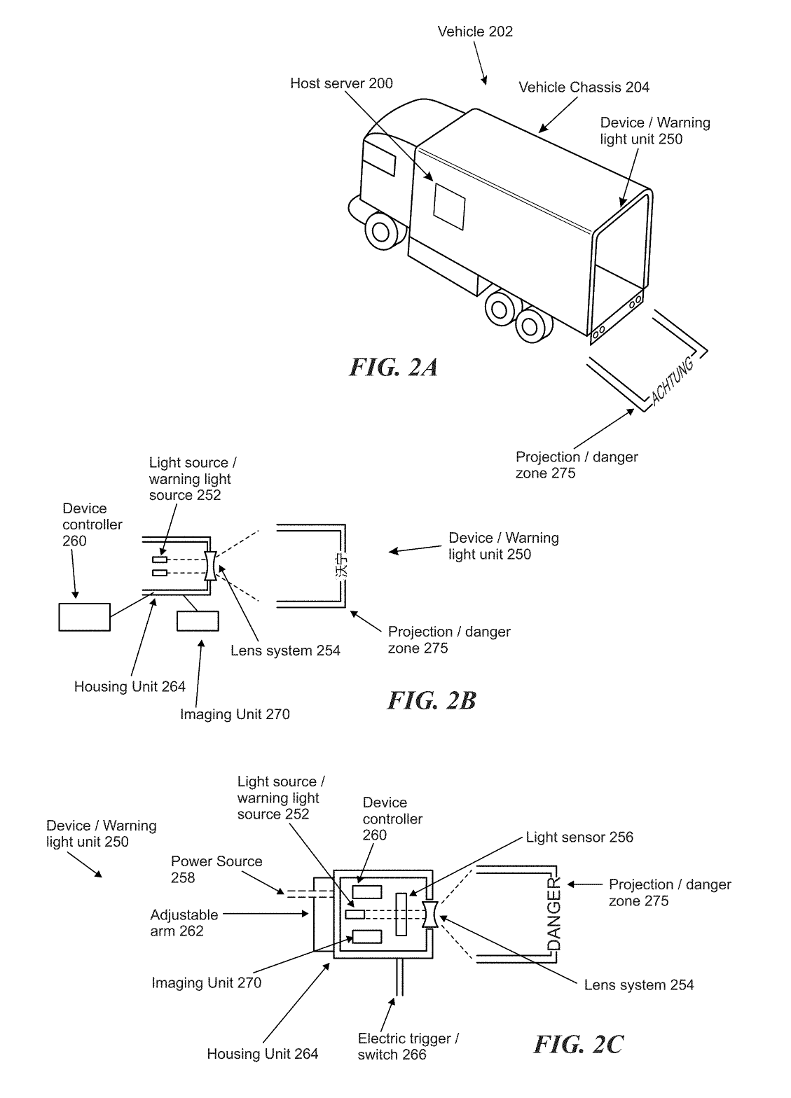

Functions and techniques performed by the device 150 and the components therein are described in detail with further references to the examples of FIG. 2B-FIG. 2C.

FIG. 2A illustrates an example diagram depicting a side view of a vehicle 202 having a vehicle chassis 204 and a device/warning light unit 250 to generate a light projection 275 to illuminate a potentially dangerous or hazardous zone 275, in accordance with embodiments of the present disclosure.

In one embodiment, the vehicle 202 includes an internal power source (not shown) in the vehicle chassis 204. The warning light unit 250 can be coupled to the vehicle chassis 204, for example, as an add on unit, which can be attached and removed from the vehicle chassis 204. The warning light unit 250 can also be manufactured or built to be integrated with or within the vehicle chassis 204, in part or in whole.

The warning light unit 250 can include, for example, one or more of: a light source (e.g., light source 252 of FIG. 2B-FIG. 2C) to generate a warning light and a lens system (e.g., lens system 254 of FIG. 2B-FIG. 2C). optically coupled to the light source. The light source can be arranged to and configured to be able to generate the warning light for projection in the physical space in a vicinity of the vehicle 202. Note that in operation, the lens system can be adapted to focus or disperse the lighting to illuminate a physical space based on a position of the physical space relative to the vehicle 202 and/or an area of the physical space.

One embodiment of the vehicle 202 further includes an adjustable arm (e.g., adjustable arm 262 as shown in the example of FIG. 2C) coupled to the warning light unit 250 and the vehicle chassis 204. The adjustable arm can configured to or coupled to the vehicle 202 to adjust an angle or position of the warning light projected in the physical space to illuminate, highlight or otherwise indicate the danger zone 275.

The warning light unit 250 can also include a power source to power the light source. The power source is in one embodiment electrically coupled to the internal power source of the vehicle 202 and can be in part or in whole powered by the internal power unit of the vehicle 202. For example the power source can be powered using the engine of the vehicle 202. The power source can also be in part or in whole powered by an external source such as an external battery (electrical power) or photo voltaic cell (solar power).

In one embodiment the warning light unit 250 includes a trigger (e.g., mechanical trigger, electrical trigger, etc.) coupled to a vehicle door that is integrated with the vehicle chassis 204. The trigger (e.g., trigger/switch 266 as illustrated in the example of FIG. 2C) can be, for example, activated responsive to detection of opening of the vehicle door. The activation of the trigger can also cause the light source to be powered on in order to generate and project lighting into a physical space to indicate a dangerous or potentially dangerous zone.

FIG. 2B-FIG. 2C depict multiple views of an example apparatus 250 (e.g., device/warning light unit 250) to generate and project light to indicate a danger zone or a potentially dangerous zone 275 in in the vicinity of a vehicle, in accordance with embodiments of the present disclosure.

In one embodiment, the apparatus includes the device/warning light unit 250 which can include a light source 252 (e.g., warning light source 252) and/or a lens system 254 coupled to the light source 252. In operation, the light source 252 is able to generate the lighting for projection (e.g., danger zone projection 275) in the physical space adjacent to the commercial vehicle. The lens system 254 can focus or disperse the lighting to illuminate the physical space based on for example, a position of the physical space relative to the commercial vehicle and/or an area of the physical space.

The light source 252 can include a semiconductor lighting emitting device or opto-electronic device. For example, the semiconductor lighting emitting device can include one or more of, at least one light emitting diode, at least one laser diodes, and a combination of one or more light emitting diodes and one or more laser diodes. A further embodiment of the warning light unit 250 includes a light sensor 256 coupled to the light source 252 (e.g., warning light source 252). The light sensor 256 can activate the light source when ambient light or available light is below a threshold.

In general, the lens system 254 can include concave lenses and/or convex lenses. The lens system 254 can also include an array of lenses having any combination of concave lens and convex lens. In some instances, the lens system 254 is communicatively coupled to a lens controller (e.g., the lens controller can be a part of device controller 260 or be a controller separate from device controller 260) to adjust the position and/or orientation of each lens in the array of lenses of the lens system 254 based on the desired or optimal positioning or brightness/sharpness of the projection indicating the danger zone 275 for a given scenario (e.g., the instant road condition, ambient lighting, visibility, traffic density, etc.).

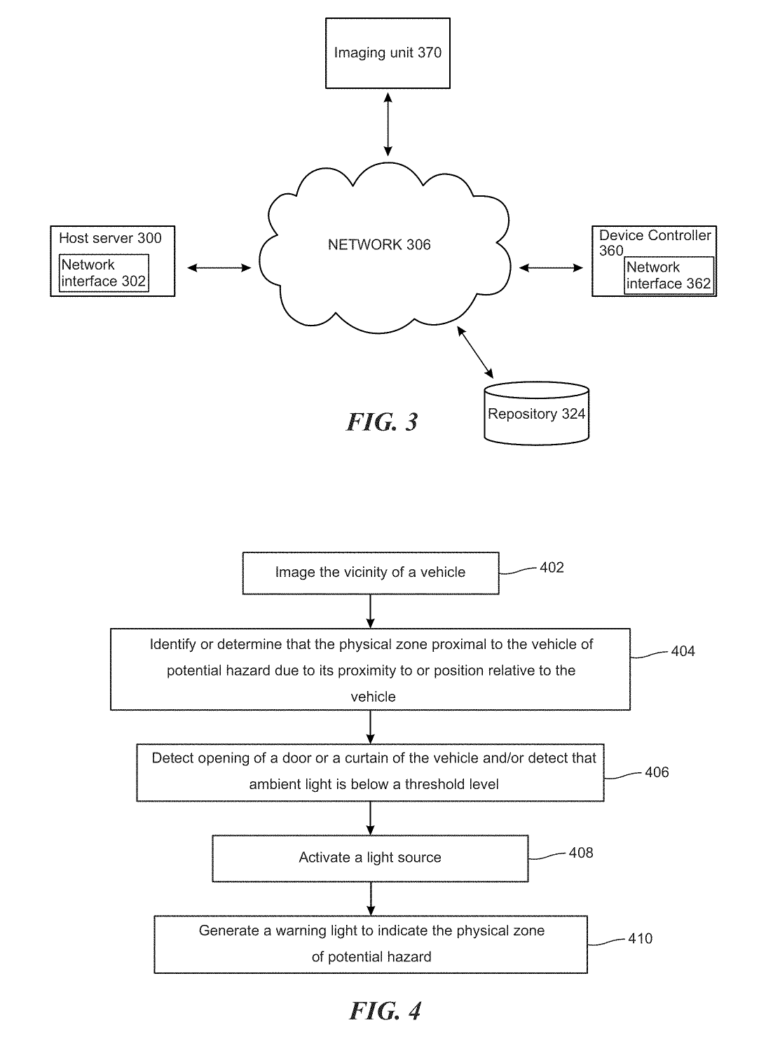

In a further embodiment, the warning light unit 250 includes a device controller 260 operably coupled to one or more of the light source and the lens system 254. The device controller 260 can include, for example, a network interface (e.g., a network interface 362 as shown in the example of FIG. 3) able to receive or transmit data (e.g., from or to the host server 200 shown in the example of FIG. 2A) to facilitate operation of the apparatus 250.

The apparatus/warning light unit 250 can also include a housing unit 264 to enclose the light source 252 and/or the lens system 254. The housing unit 264 can further enclose a light sensor 256 coupled to the light source 262. The light sensor 256 can activate the light source 252 when ambient light or available light is below a threshold. The light sensor may also detect visibility and activate the light source 252 when the visibility is below a given threshold (e.g., in foggy or raining conditions). A further embodiment of the apparatus or warning light unit 250 further includes an adjustable arm 262 attached to the housing unit 264. The adjustable arm 262 can be configured to adjust one or more of an angle and position of the lighting projected 275 in the physical space.

The warning light unit 250 can also include a power source 258 that is electrically coupled to the light source 262. In one embodiment, the power source 258 can be adapted to be coupled to an internal power source (not shown) of commercial vehicle 202. The power source 258 can also be coupled to an electrical trigger/switch 266 to manually control operation of the apparatus/warning light unit 250. The electrical trigger/switch 266 can also be coupled to an interior lighting system (not shown) of the commercial vehicle 202. In a further embodiment, the electrical trigger/switch 266 is coupled to the light sensor 256 such that the electrical trigger 266 is activated responsive to the light sensor 256 sensing ambient light or available light is below a threshold.

One embodiment of the apparatus/warning light unit 250 further includes an imaging unit 270 coupled to the housing unit 264 or integrated within the housing unit 264. The imaging unit 270 can be arranged to image a rear side of the commercial vehicle 202 to provide visibility of the rear side of the commercial vehicle 202 to an operator, driver, or other user of the commercial vehicle 202. For instance, the imaging unit 270 can function as a rear view mirror for an operator or driver of the vehicle. The imaging unit 270 can also be arranged to image physical spaces surrounding the commercial vehicle 202 to determine that a given physical space among the physical spaces is potentially in a danger zone.

Functions and techniques performed by the device controller 260 and the components therein are also described in detail with further references to the examples of FIG. 3.

FIG. 3 illustrates an example block diagram depicting a host server 300 able to communicate with a device controller 360 of a warning light unit and/or an imaging unit 370 over a network 306, in accordance with embodiments of the present disclosure.

The device controller(s) 360 (or controller) can be any system and/or device, and/or any combination of devices/systems that is able to establish a connection with another device, a server and/or other systems. Device controller(s) 360 each typically communicates data or instructions between a device warning light unit (e.g., device 150 of FIG. 1A-FIG. 1B and/or the device/warning light unit 250 of FIG. 2A-FIG. 2B) which projects lighting in a physical space in a vicinity of a vehicle and the host server 300.

The device controller 360 can also include a network interface 362. The network interface 302 can be a networking module that enables the device controller 360 to mediate data in a network with an entity that is external to the device controller 360, through any known and/or convenient communications protocol supported by the host and the external entity. The device controller 360 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

Note that the device controller 360 can be embedded and/or integrated in or with the device (e.g., device 150 of FIG. 1A-FIG. 1B and/or the device/warning light unit 250 of FIG. 2A-FIG. 2B). In addition, the device controller 360 can include software agent and/or modules coupled to or integrated in a client device or user device. The client device or user device can be standalone from the device warning light unit (e.g., device 150 of FIG. 1A-FIG. 1B and/or the device/warning light unit 250 of FIG. 2A-FIG. 2B) which projects lighting in a physical space in a vicinity of a vehicle .

For example, the client devices can include a mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device and/or any other portable, mobile, hand held devices, etc. The input mechanism on client devices can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, voice, audio, gesture, or a combination of the above.

The device controller(s) 360, client devices , host server 300, its respective networks of users can be coupled to the network 306 and/or multiple networks. In some embodiments, the device controller 360 and host server 300 may be directly connected to one another. In one embodiment, the host server 300 is operable to facilitate, manage, oversee, control, adjust, change, and/or adapt various aspects of light projection in a physical space adjacent to or in a vicinity of a vehicle (e.g., commercial vehicle or lorry), for example, via a device/warning light unit (e.g., device 150 of FIG. 1A-FIG. 1B and/or the device/warning light unit 250 of FIG. 2A-FIG. 2B).

The host server 300 can further facilitate indication of a physical zone of potential hazard in a vicinity of a vehicle, for example. The host server 300 can be integrated with the vehicle (e.g., host server 100 of vehicle 102 shown in the examples of FIG. 1A-FIG. 1B, and/or host server 200 of vehicle 202). Alternatively, the host server 300 can include software agents and/or modules coupled to or integrated in a client device or user device that is standalone from the vehicle adjacent to which a warning light can be projected.

In general, network 306, over which the device controller(s) 360, client devices , the host server 300, and/or end users communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 306 can be any collection of distinct networks operating wholly or partially in conjunction to provide connectivity to the device controller 360, the client devices and the host server 300 and may appear as one or more networks to the serviced systems and devices. In one embodiment, communications to and from the device controller 360 and/or any client devices can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 300 and/or the device controller 360 may include internally or be externally coupled to a repository or repositories 324 including, for example, a user repository a metadata repository and/or a device parameter repository. The repositories 324 can store software, descriptive data, images, system information, drivers, and/or any other data item utilized by other components of the host server 300, the device controller 360 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 300 is able to generate, create and/or provide data to be stored in the user repository ,the metadata repository and/or the device parameter repository 132.

The device parameter repository can store settings, warning light device IDs, device type, sensor specifications, light source specifications, lens system configuration data, power source specifications, housing unit specifications, electrical trigger/switch configurations, and/or various parameters of components in the warning light devices, user type, user/operator instructions or requirements, installation data, firmware files and/or configuration data of device controllers 360. The metadata repository is able to store tags, tag statistics, tag parameters, metadata, metadata statistics for operation, usage statistics, road conditions, vehicle parameters, vehicle dimensions, illumination data, illumination settings or ambient lighting information.

Additional or less modules can be included without deviating from the techniques discussed in this disclosure. In addition, each module in the example of FIG. 3 can include any number and combination of sub-modules, and systems, implemented with any combination of hardware and/or software modules.

The host server 300 and/or device controller 260, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The host server 300 can also include a network interface 302. The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

FIG. 4 depicts a flow chart illustrating an example process to indicate a zone of hazard in a vicinity of a vehicle, in accordance with embodiments of the present disclosure.

In process 402, the vicinity of a vehicle (e.g., a commercial vehicle, a truck, a minivan, a lorry, etc.) is imaged. The imaging can be performed by, for example, the imaging unit 270 of the example of FIG. 2A-FIG. 2B and/or the imaging unit 370 of the example of FIG. 3. For instance, physical spaces surrounding the commercial vehicle can be imaged to identify or determine that the physical space among the physical spaces is potentially in a danger zone. In addition, a rear side of the commercial vehicle can also be imaged (e.g. by the imaging unit) to provide visibility of the rear side of the commercial vehicle to an operator of the vehicle, for example, to operate as a rear view mirror.

In process 404, a physical zone proximal to the vehicle can be identified or determined to be of potential hazard due to its proximity to or position relative to the commercial vehicle, In process 406, opening of a door or a curtain of the vehicle is detected and/or ambient light is detected to be below a threshold level. In process 408, a light source is activated. In process 410, a warning light can be generated to indicate the physical zone of potential hazard near the vehicle.

In general the potential danger can arise from for example, loading or unloading activity to or from the vehicle. Example applications of the present disclosure include by way of example: HGV's, small to large commercial/transport vehicles for public & working environments. The disclosed innovation can be suitable for vehicles deployed in, by way of example and not limitation, airfields, docks, ship yards, warehouse loading bays, or anywhere where vehicles are in operation in low light. The disclosed innovation can be applied in various industries e.g., from construction to commerce.

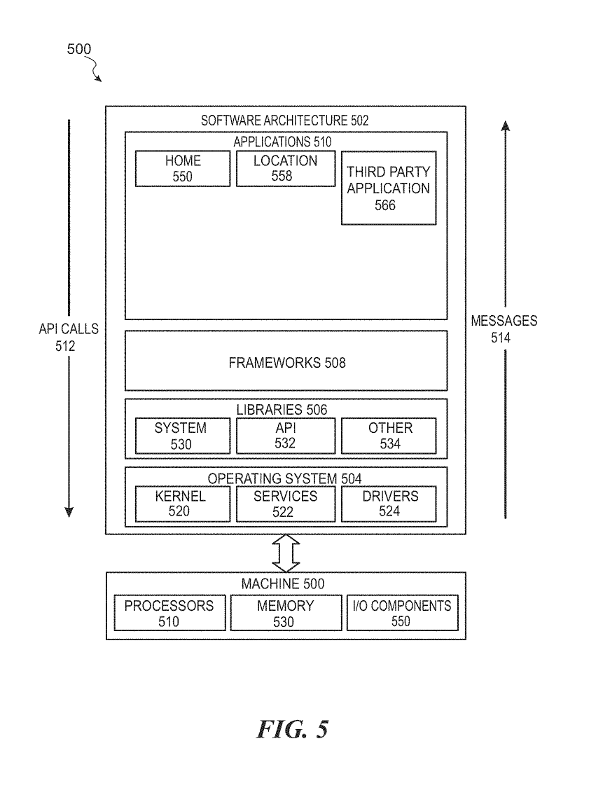

FIG. 5 is a block diagram illustrating an example of a software architecture 1400 that may be installed on a machine, in accordance with embodiments of the present disclosure.

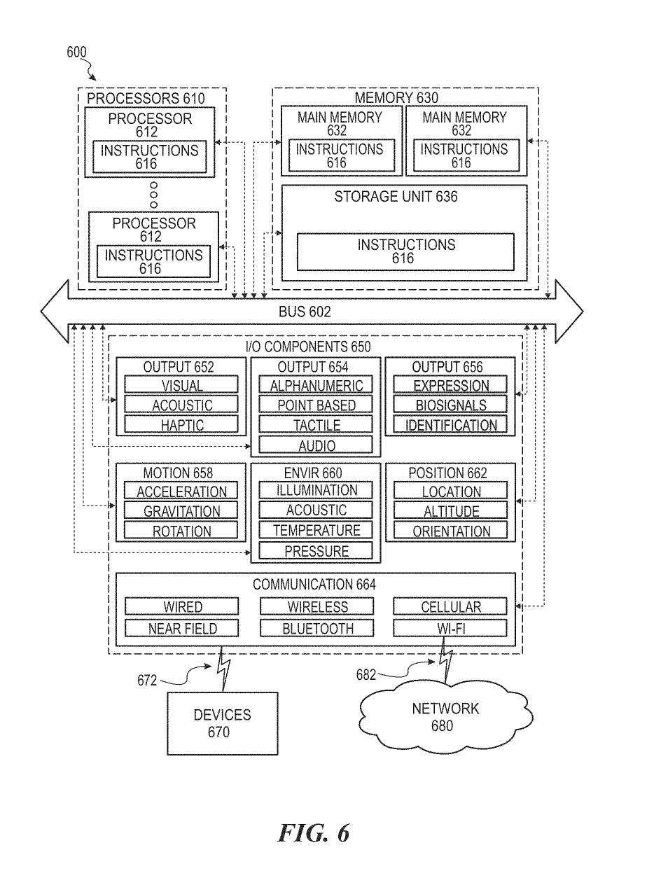

FIG. 5 is a block diagram 500 illustrating an architecture of software 502, which can be installed on any one or more of the devices described above. FIG. 5 is a non-limiting example of a software architecture, and it will be appreciated that many other architectures can be implemented to facilitate the functionality described herein. In various embodiments, the software 502 is implemented by hardware such as machine 600 of FIG. 6 that includes processors 610, memory 630, and input/output (I/O) components 650. In this example architecture, the software 502 can be conceptualized as a stack of layers where each layer may provide a particular functionality. For example, the software 502 includes layers such as an operating system 504, libraries 506, frameworks 508, and applications 510. Operationally, the applications 510 invoke API calls 512 through the software stack and receive messages 514 in response to the API calls 512, in accordance with some embodiments.

In some embodiments, the operating system 504 manages hardware resources and provides common services. The operating system 504 includes, for example, a kernel 520, services 522, and drivers 524. The kernel 520 acts as an abstraction layer between the hardware and the other software layers consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH drivers, flash memory drivers, serial communication drivers (e.g., Universal Serial Bus (USB) drivers), WI-FI drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematics functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphic user interface (GUI) functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a location application 558, and other applications such as a third party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third party application 566 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 566 can invoke the API calls 512 provided by the operating system 504 to facilitate functionality described herein.

FIG. 6 is a block diagram illustrating components of a machine 600, according to some example embodiments, able to read a set of instructions from a machine-readable medium (e.g., a machine-readable storage medium) and perform any one or more of the methodologies discussed herein.

Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein can be executed. Additionally, or alternatively, the instruction can implement any module of FIG. 2B-2C and any module of FIG. 3, and so forth. The instructions transform the general, non-programmed machine into a particular machine programmed to carry out the described and illustrated functions in the manner described.

In alternative embodiments, the machine 600 operates as a standalone device or can be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 can include processors 610, memory/storage 630, and I/O components 650, which can be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 612 and processor 610 that may execute instructions 616. The term “processor” is intended to include multi-core processor that may comprise two or more independent processors (sometimes referred to as “cores”) that can execute instructions contemporaneously. Although FIG. 6 shows multiple processors, the machine 600 may include a single processor with a single core, a single processor with multiple cores (e.g., a multi-core processor), multiple processors with a single core, multiple processors with multiples cores, or any combination thereof.

The memory/storage 630 can include a main memory 632, a static memory 634, or other memory storage, and a storage unit 636, both accessible to the processors 610 such as via the bus 602. The storage unit 636 and memory 632 store the instructions 616 embodying any one or more of the methodologies or functions described herein. The instructions 616 can also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 1216. The term “machine-readable medium” or “machine-readable storage medium” shall also be taken to include any medium, or combination of multiple media, that is capable of storing, encoding or carrying a set of instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 650 can include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 can include many other components that are not shown in FIG. 6. The I/O components 650 are grouped according to functionality merely for simplifying the following discussion and the grouping is in no way limiting. In example embodiments, the I/O components 650 can include output components 652 and input components 654. The output components 652 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 652 can include biometric components 656, motion components 658, environmental components 660, or position components 662 among a wide array of other components. For example, the biometric components 656 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 can include acceleration sensor components (e.g., an accelerometer), gravitation sensor components, rotation sensor components (e.g., a gyroscope), and so forth. The environmental components 660 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 662 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 650 may include communication components 664 operable to couple the machine 600 to a network 680 or devices 670 via a coupling 682 and a coupling 672, respectively. For example, the communication components 664 include a network interface component or other suitable device to interface with the network 680. In further examples, communication components 664 include wired communication components, wireless communication components, cellular communication components, Near Field Communication (NFC) components, Bluetooth. components (e.g., Bluetooth. Low Energy), WI-FI components, and other communication components to provide communication via other modalities. The devices 670 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 664 can detect identifiers or include components operable to detect identifiers. For example, the communication components 664 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 664, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 1080 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI.RTM. network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or other type of cellular or wireless coupling. In this example, the coupling 682 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 616 can be transmitted or received over the network 680 using a transmission medium via a network interface device (e.g., a network interface component included in the communication components 664) and utilizing any one of a number of transfer protocols (e.g., HTTP). Similarly, the instructions 616 can be transmitted or received using a transmission medium via the coupling 672 (e.g., a peer-to-peer coupling) to devices 670. The term “transmission medium” shall be taken to include any intangible medium that is capable of storing, encoding, or carrying the instructions 616 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶ 6, other aspects may likewise be embodied as a means-plus-function claim, or in other forms, such as being embodied in a computer-readable medium. (Any claims intended to be treated under 35 U.S.C. § 112, ¶ 6 will begin with the words “means for”.) Accordingly, the applicant reserves the right to add additional claims after filing the application to pursue such additional claim forms for other aspects of the disclosure.

What is claimed is:

1. An apparatus to project lighting in a physical space adjacent to a commercial vehicle, the apparatus, comprising:
a light source;
a lens system optically coupled to the light source, wherein, in operation the lens system is adapted to focus or disperse the lighting to illuminate the physical space based on at least one of a position of the physical space relative to the commercial vehicle and an area of the physical space;
wherein, in operation, the light source is able to generate the lighting for projection in the physical space adjacent to the commercial vehicle.

2. The apparatus of claim 1, wherein, the light source includes a semiconductor lighting emitting device.

3. The apparatus of claim 2, wherein,
the semiconductor lighting emitting device includes one or more of, at least one light emitting diode, at least one laser diodes, and a combination of one or more light emitting diodes and one or more laser diodes.

4. The apparatus of claim 1, further comprising,
a light sensor coupled to the light source;
wherein, the light sensor activates the light source when ambient light or available light is below a threshold.

5. The apparatus of claim 1, wherein, the lens system comprises one or more concave lens or one or more convex lens.

6. The apparatus of claim 1, wherein, the lens system comprises an array of lenses having any combination of concave lens and convex lens.

7. The apparatus of claim 1, further comprising,
a device controller operably coupled to one or more of the light source and the lens system;
wherein, the device controller further comprises a network interface, the network interface being able to receive or transmit data to facilitate operation of the apparatus.

8. The apparatus of claim 1, further comprising, a housing unit to enclose one or more of the light source and the lens system.

9. The apparatus of claim 8,
wherein, the housing unit further encloses a light sensor coupled to the light source;
further wherein, the light sensor activates the light source when ambient light or available light is below a threshold.

10. The apparatus of claim 8, further comprising,
an adjustable arm attached to the housing unit;
wherein, the adjustable arm is configured to adjust one or more of an angle and position of the lighting projected in the physical space.

11. The apparatus of claim 1, further comprising, a power source electrically coupled to the light source.

12. The apparatus of claim 11, wherein, the power source is adapted to be coupled to an internal power source of commercial vehicle.

13. The apparatus of claim 11, further comprising, an electrical trigger coupled to the power source to manually control operation of the apparatus;
wherein, the electrical trigger is configured to be coupled to an interior lighting system of the commercial vehicle.

14. The apparatus of claim 4, further comprising,
an electrical trigger coupled to the light sensor;
wherein, the electrical trigger is activated responsive to the light sensor sensing ambient light or available light is below a threshold.

15. The apparatus of claim 8, further comprising,
an imaging unit coupled to the housing unit;
wherein, the imaging unit is arranged to image a rear side of the commercial vehicle to provide visibility of the rear side of the commercial vehicle to an operator of the commercial vehicle;
wherein, the imaging unit is further arranged to image physical spaces surrounding the commercial vehicle to determine that the physical space among the physical spaces is potentially in a danger zone.

16. A method to indicate a physical zone of potential hazard in a vicinity of a vehicle, the method, comprising:
identifying or determining that the physical zone proximal to the vehicle of potential hazard due to its proximity to or position relative to the commercial vehicle;
activating a light source, wherein, upon activation, the light source generates a warning light to indicate the physical zone of potential hazard.

17. The method of claim 16, further comprising,
imaging the vicinity of the vehicle to identify the physical zone of potential hazard;
wherein, the light source is activated in response to one or more of, detecting opening of a door or a curtain of the vehicle and detecting that ambient light is below a threshold level;
wherein, the potential danger arises from loading or unloading activity to or from the vehicle.

18. A vehicle, comprising:
a vehicle chassis;
an internal power source in the vehicle chassis;
a warning light unit coupled to the vehicle chassis, the warning light unit having:
a light source to generate a warning light;
a lens system optically coupled to the light source, wherein, in operation the lens system is adapted to focus or disperse the lighting to illuminate a physical space based on at least one of a position of the physical space relative to the vehicle and an area of the physical space;
wherein, in operation, the light source is able to generate the warning light for projection in the physical space in a vicinity of the vehicle

19. The vehicle of claim 18, further comprising:
an adjustable arm coupled to the warning light unit and the vehicle chassis;
wherein, in operation, the adjustable arm is configured to adjust an angle or position of the warning light projected in the physical space;
wherein, the warning light unit unit further comprises:
a power source;
wherein, the power source is electrically coupled to the internal power source of the vehicle.

20. The vehicle of claim 18, further comprising:
a vehicle door integrated with the vehicle chassis;
wherein, the warning light unit further comprises:
a trigger coupled to the vehicle door;
wherein, in operation, the trigger is activated responsive to detection of opening of the vehicle door.
